(19) United States
(12) Patent Application Publication
(10) Pub. No.: US 2025/0256627 A1
(43) Pub. Date: Aug. 14, 2025

(54) SEAT

(71) Applicant: TOYOTA BOSHOKU KABUSHIKI KAISHA, Aichi-ken (JP)

(72) Inventor: Satoru OHIRA, Toyota-shi (JP)

(73) Assignee: TOYOTA BOSHOKU KABUSHIKI KAISHA, Aichi-ken (JP)

(21) Appl. No.: 19/047,075

(22) Filed: Feb. 6, 2025

(30) Foreign Application Priority Data
Feb. 8, 2024 (JP) 2024-017694

(51) Int. Cl. B60N 2/56; A47C 7/74

(52) U.S. Cl. CPC B60N 2/5642; B60N 2/565; A47C 7/744

(57) ABSTRACT

A seat has a cushion body, a back frame to support the cushion body, a seat pad to elastically support an occupant, and a covering member. The seat pad has a central pad forming a center portion and two side pads forming two side portions. The central pad has ventilation through holes, which have openings outwardly facing the two side pads. The covering member is adjacent a side surface of the central pad. The seat further has a blower to draw air from the cushion body.

### CROSS-REFERENCE TO RELATED APPLICATION

This application claims priority to Japanese patent application serial number 2024-017694, filed Feb. 8, 2024, the content of which is incorporated herein by reference in its entirety for all purposes.

### TECHNICAL FIELD

The present disclosure relates to a seat. In particular, the present disclosure relates to a seat having a seat pad that elastically supports an occupant on the seat.

### BACKGROUND

For example, a prior art discloses a seat having ventilation holes formed in a seat pad for allowing air to pass through in the thickness direction of the pad. The ventilation holes are formed to open on the pad surface of the seat pad. A blower arranged on the back side of the pad draws air on the front side of the seat via the ventilation holes so as to improve the comfort of an occupant on the seat. The ventilation holes are arranged at positions close to the outer edge of the seat pad in the seat width direction to avoid being blocked by the occupant.

In the configuration of the above prior art, when the seat pad is divided into a central pad, which forms the center portion in the seat width direction, and each side pad, which forms the side portions, it is difficult to arrange the ventilation holes formed in the central pad close to the outer edge of the seat pad in the seat width direction. The reason is that if the ventilation holes are too close to the edge of the central pad, the thickness of the peripheral wall of the ventilation holes cannot be properly secured. Therefore, the present disclosure provides a seat having a ventilation hole which can be appropriately arranged at a position closer to the edge of the central pad even if the central pad is separated from side pads.

### SUMMARY OF THE DISCLOSURES

According to one aspect of the present disclosure, a seat having a seat pad elastically supporting an occupant, the seat pad comprising three divided elements. The three elements are a central pad forming a center portion in the seat width direction and each side pad forming a side portion in the seat width direction. Ventilation holes are provided on the side edges of the central pad opposed to the side pad in the seat width direction. The ventilation hole penetrates in the pad thickness direction so as to open outwardly in the seat width direction. The seat further has a covering member which abuts to the side surface of the central pad so as to cover the ventilation hole from the outside in the seat width direction.

### BRIEF DESCRIPTION OF DRAWINGS

FIG. 1 is a perspective view of the schematic configuration of a seat in accordance with an embodiment.

FIG. 2 is an exploded perspective view of a seat back of FIG. 1.

FIG. 3 is a front view of the seat back of FIG. 1.

FIG. 4 is a perspective view of a central portion of FIG. 1, viewed from the rear-side.

FIG. 5 is a cross-sectional view taken along a line V-V in FIG. 3.

FIG. 6 is an enlarged perspective view of the side surface of a central pad and an extending portion of a flow path cover.

### DETAILED DESCRIPTION

An embodiment of the present disclosure will be described with reference to the drawings.

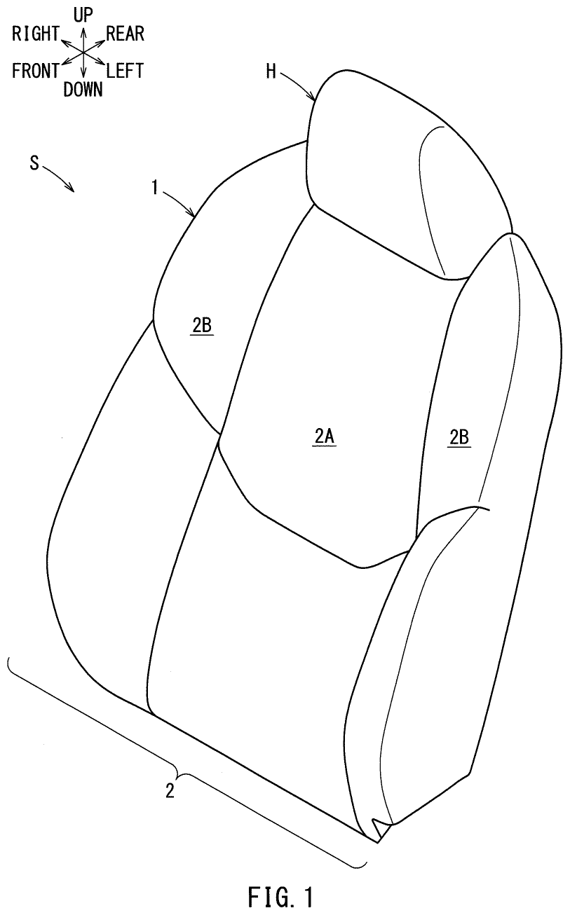

First, the configuration of a seat S according to an embodiment of the present disclosure will be explained with reference to FIGS. 1 to 6. In the following description, when each direction such as front/rear, up/down, and right/left is indicated, it shall refer to the respective direction indicated in each figure.

When “seat” is appended to each direction, such as “seat width direction,” it shall refer to the respective direction with respect the seat S. In the following explanation, when a specific reference figure is not shown or when there is no corresponding sign in the reference figure, one of the figures from FIGS. 1 to 6 shall be referred to as appropriate.

As shown in FIG. 1, the seat S is a one-seater seat in an automobile. The seat S comprises a seat back 1 which serves as a backrest for an occupant, a seat cushion (not shown) which serves as a seating portion, and a headrest H which serves as a headrest.

The seat back 1 is connected to the right and left rear ends of the seat cushion via a recliner (not shown) at the lower ends of the right and left sides of the seat back 1. Thereby, the seat back 1 is able to adjust the angle of its back recline with respect to the seat cushion as required.

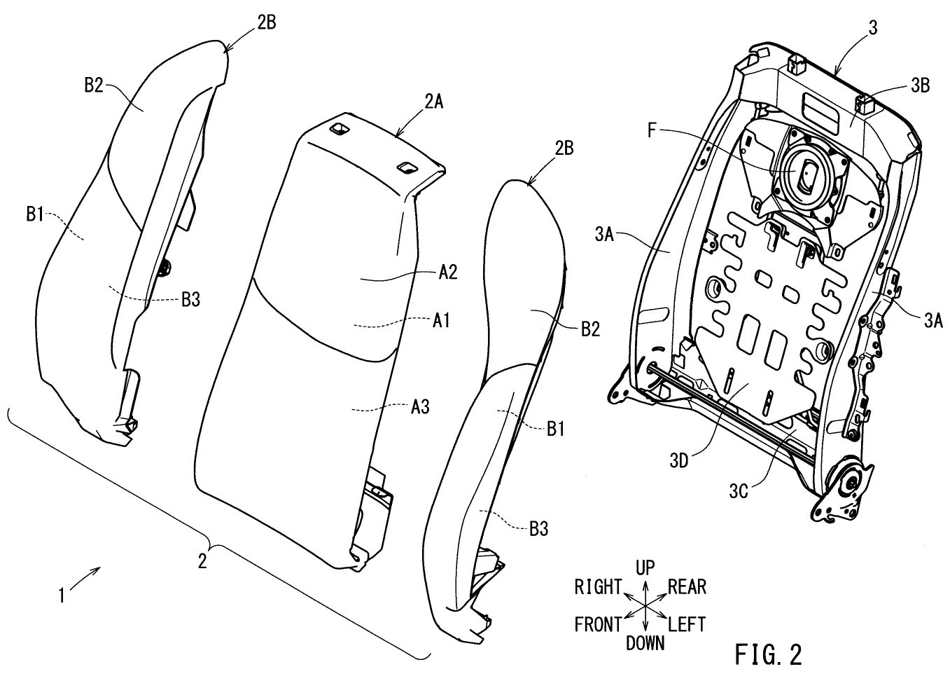

As shown in FIG. 2, the seat back 1 has a cushion body 2 which elastically supports the back of the occupant and a back frame 3 which supports the cushion body 2 from the back side (rear side) of the seat. The cushion body 2 is divided into three separate elements. The three elements are a central portion 2A, which is the center portion in the seat width direction, and each side portion 2B, which forms the side portions in the seat width direction.

The back frame 3 is a metal member assembled in a frame shape in front view. A lumbar support 3D is provided inside the frame of the back frame 3. The lumber support 3D enhances the support of the occupant's lower back. The seat back 1 is further provided with a blower F which is attached on the upper area of the lumbar support 3D.

The blower F functions as a seat ventilation, which draws out heated air between the occupant and the seat back 1 from the seat front side of the cushion body 2. This function enhances the ventilation of the seat front side of the cushion body 2 and improves the comfort of the occupant.

The cushion body 2 is divided into the central portion 2A and each side portion 2B as described above, so that each divided element can be replaced. The central portion 2A and side portions 2B can be easily assembled to the back frame 3 by access from the front of the seat.

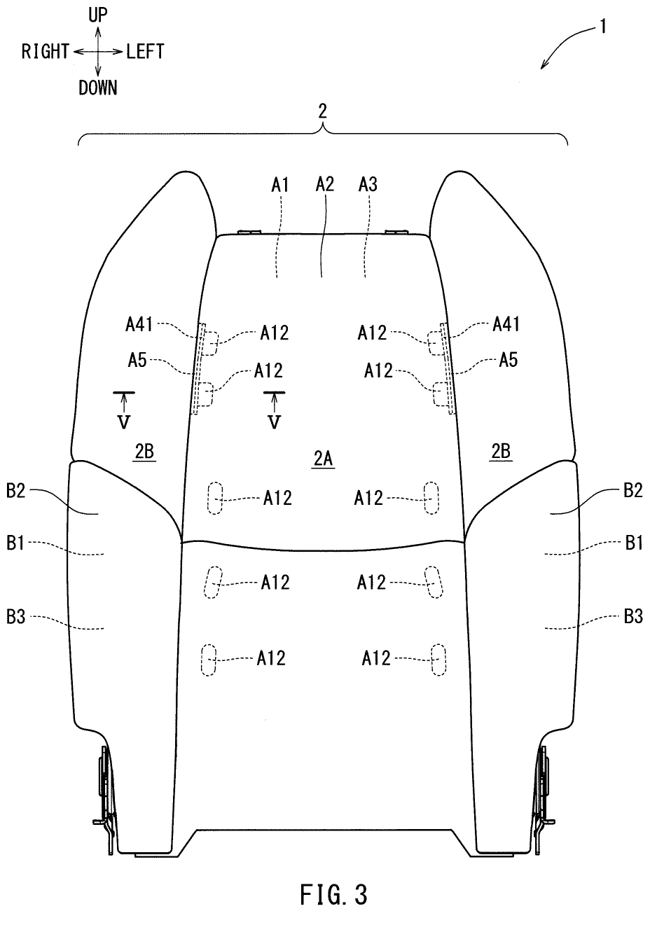

As shown in FIG. 3, the central portion 2A has a plurality of ventilation through holes A12 for passing air from the seat front side by the blower F (see FIG. 2). Each ventilation through hole A12 is formed in two positions along both edges of the central portion 2A in the seat width direction, at two locations on the left and right sides, with five holes aligned vertically.

Each of the lower six ventilation through holes A12, which are located at the right and left symmetrical positions, are formed at a position spaced apart inwardly from both edges of the central portion 2A in the seat width direction. On the other hand, each of the upper four ventilation through holes A12, which are located at the right and left symmetrical positions, are formed at both edges of the central portion 2A in the seat width direction.

By being arranged in such a manner, each ventilation through hole A12 is provided so as to be aligned along both sides of the torso in accordance with the physique of the occupant, i.e., the shape of the torso, which becomes wider the higher up it goes. Therefore, each ventilation through hole A12 is difficult to be blocked even when the occupant leans against the seat back 1.

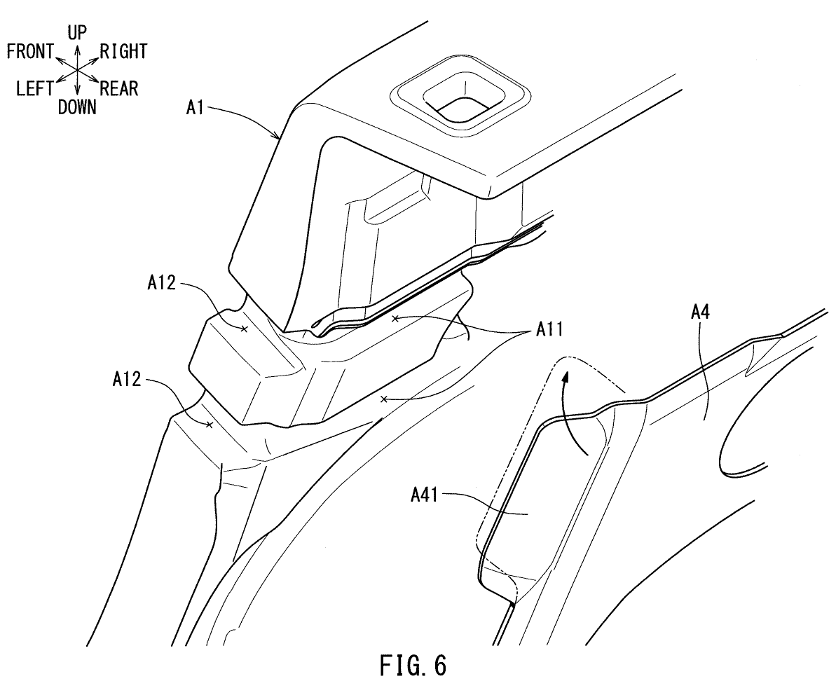

The four ventilation through holes A12, which is the upper two ventilation through holes A12 located at the right and left symmetrical positions, are formed so as to open outward in the seat width direction on both edges of the central portion 2A of a central pad A1 (see FIG. 6). Therefore, if the configuration of the seat pad is only the central pad A1, these ventilation through holes A12 have an opening shape that allows air to leak outward in the seat width direction.

However, the central portion 2A has a configuration that can appropriately cover each ventilation through hole A12 from outside in the seat width direction (that is, a configuration of an extending portion A41 and a planar member A5 described below) even if each ventilation through hole A12 is formed in such a position. The specific configuration of the central portion 2A will be described in detail below, together with the configuration of each part of the seat back 1.

First, the configuration of the back frame 3 will be described. As shown in FIG. 2, the back frame 3 has a pair of side frames 3A extending in the seat height direction along both right and left sides of the seat back 1. The side frame has a long plate-like shape.

The back frame 3 also has an upper frame 3B extending in the seat width direction along the upper part of the seat back 1. The back frame 3 also has a lower frame 3C extending in the seat width direction along the lower part of the seat back 1.

The back frame 3 further has the lumbar support 3D which is suspended from the upper frame 3B between the side frames 3A. The lower part of the lumbar support 3D is elastically supported from the back side of the seat by the lower frame 3C via a spring (not shown). The blower F described above is attached in the upper area of the lumbar support 3D which is suspended from the upper frame 3B.

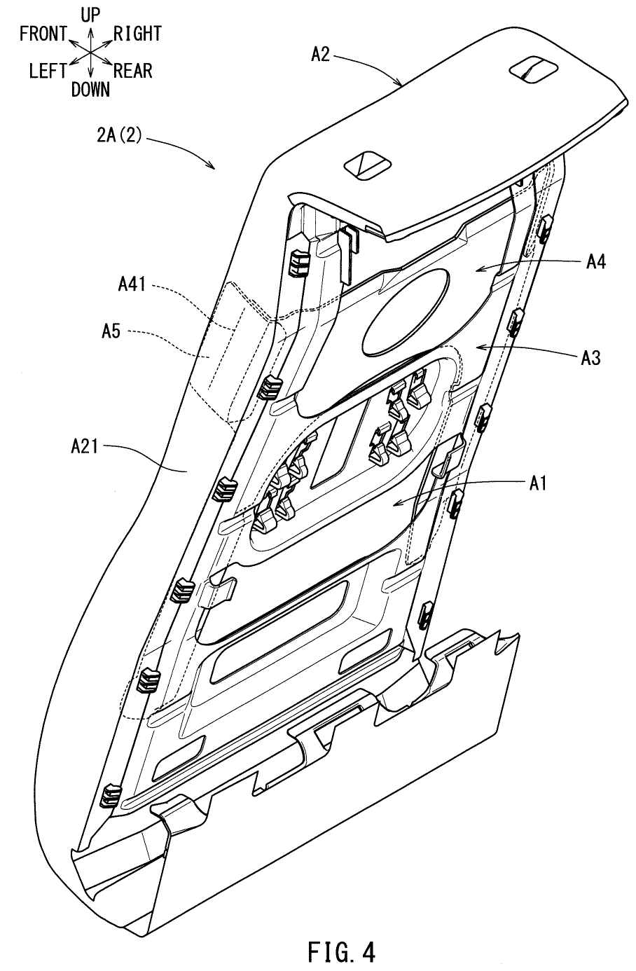

Next, the configuration of the central portion 2A and the side portions 2B will be described. As shown in FIGS. 2 and 4, the central portion 2A has the central pad A1, a central cover A2, and a central substrate A3. The central pad A1 is made of urethane foam. The central cover A2 is made of fabric and covers the central pad A1. The central substrate A3 is made of resin and is attached to the central pad A1 from the back side of the pad.

The central pad A1 is covered with the central cover A2 from the front side of the pad. The central cover A2 has its upper, right, and left cover ends pulled into the back side of the central pad A1. Each cover end of the central cover A2 is then fastened to each edge of the central substrate A3, which is attached to the back surface of the central pad A1.

By being attached as described above, the central cover A2 is integrated with the central substrate A3 so that the central pad A1 is wrapped between the central cover A2 and the central substrate A3. Thereby, the central substrate A3 is abutted and fixed to the back side of the central pad A1 by the central cover A2.

As shown in FIG. 2, when the central portion 2A is assembled to the back frame 3, the lower end of the central cover A2 is pulled toward the rear side of the seat to wrap around the lower frame 3C from the lower side and is fastened to the lower frame 3C. Details are described below.

Also, the side portion 2B has a side pad B1, a side cover B2, and a side substrate B3. The side pad B1 is made of urethane foam. The side cover B2 is made of fabric and covers the side pad B1. The side substrate B3 is made of resin and is attached to the side pad B1 from the back side of the pad. Here, the central pad A1 and each side pad B1 correspond to the “seat pad” of the present disclosure.

Each side pad B1 is covered with the corresponding side cover B2 from the front side of the pad. Each side cover B2 has its upper, lower, right, and left cover ends pulled into the back side of the corresponding side pad B1. Each cover end of these side covers B2 is then fastened to each edge of the side substrate B3, which is attached to the back surface of the corresponding side pad B1.

By being attached as described above, each side cover B2 is integrated with the side substrate B3 so that the side pad B1 is wrapped between the side cover B2 and the side substrate B3. Thereby, each side substrate B3 is fixed to the back side of the side pad B1 by the corresponding side cover B2.

The central portion 2A and the side portions 2B are individually assembled to the back frame 3 by access from the front of the seat. Specifically, the side portions 2B are first assembled to the back frame 3. The side portions 2B are assembled integrally to each side frame 3A of the back frame 3 by covering the side substrates B3 from above the seat and fastening the side substrates B3 to the side frames 3A of the back frame 3 with bolts.

After the above assembly, the central portion 2A is assembled to the back frame 3. Specifically, the central portion 2A is assembled by hooking its upper part on the upper frame 3B from above the seat.

Furthermore, the central portion 2A is fixed by pulling the lower end of the central cover A2, together with the lower part of the central pad A1, toward the rear of the seat so that it wraps around the lower frame 3C from the underside and is fastened to the lower frame 3C. According to the above assembly, the central portion 2A and the side portions 2B are integrally fixed to the back frame 3 with the gap in the seat width direction filled with each other.

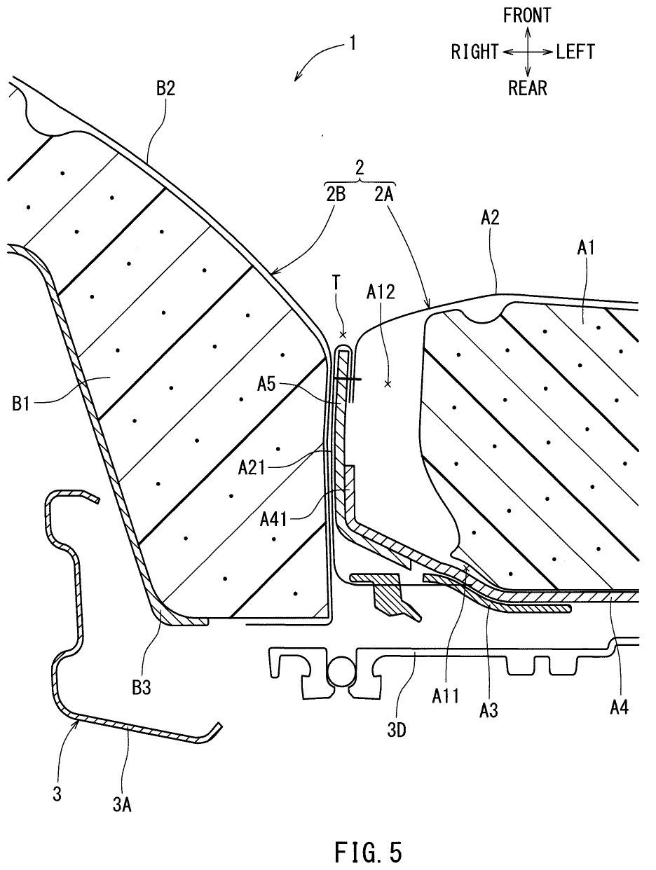

Next, the ventilation structure of the central portion 2A will be described. As shown in FIGS. 5 and 6, the central portion 2A has a flow path cover A4. The flow path cover A4 is attached to the back surface of the pad to cover an air distribution groove A11 formed along the back surface of the central pad A1. The flow path cover A4 is made of felt. The flow path cover A4 is integrally bonded to the back surface of the pad and is configured to close the air distribution groove A11 in a sealed state from the back surface of the pad.

The air distribution groove A11 functions as a ventilation flow path which is configured to move the suction pressure of the blower F (see FIG. 2) to each ventilation hole A through 12. The air distribution groove A11 extends from the connecting port of the blower F to the ventilation through hole A12 along the back surface of the central pad A1.

The ventilation through hole A12 is formed in a shape penetrating in the pad thickness direction with respect to the central pad A1 so as to connect with the air distribution groove A11 on the back surface of the central pad A1. As shown in FIG. 6, the ventilation through holes A12, which are lined up in the upper two right and left symmetrical positions formed on both edge of the central pad A1 in the seat width direction, are formed to open outwardly in the seat width direction over the entire area in the pad thickness direction.

The flow path cover A4 has the extending portion A41. The extending portion A41 bents at the edge of the flow path cover A4 in the seat width direction, and extends toward the seat front side. The extending portion A41 can cover outwardly opening ventilation through hole A12 from the outside. The extending portion A41 has an extension length that extends from the side edge of the flow path cover A4 to outside the side edge of the central pad A1 in the seat width direction. Here, the extending portion A41 corresponds to a “first abutting member” of the present disclosure.

When the central cover A2 is placed over the central pad A1, the extending portion A41 is bent from the side edge of the flow path cover A4 to the front of the seat. This allows the extending portion A41 to abut on the side surface of the central pad A1. The extending portion A41 is not bonded to the side surface of the central pad A1.

The central cover A2 has a pulling-in portion A21 (see FIG. 5). The pulling-in portion A21 is pulled into the back side of the pad. The extending portion A41 is held pressed against the side surface of the central pad A1 by the pulling-in portion A21. Thereby, the extending portion A41 covers the ventilation through hole A12, which is recessed from the side surface of the central pad A1, from the outside.

The extending portion A41 has a width that is capable of closing each of the upper two ventilation through holes A12 at right and left symmetrical positions of the central pad A1 collectively from the outside in the seat width direction. By forming such an extending portion A41 in the flow path cover A4, the air distribution groove A11 and each ventilation through hole A12, which are covered by the flow path cover A4, can be continuously closed without gaps.

As shown in FIG. 5, the extending portion A41 extends forward of the seat only to the halfway position in the pad thickness direction of the central pad A1, and the extension length does not reach the pad front surface. Although the extending portion A41 covers the ventilation hole A12 from the outside only to the halfway position in the pad thickness direction, it is less likely to cause a foreign body sensation when the central pad A1 bends due to occupant seating.

The reason is that the extending portion A41, which are made of a felt harder than the central cover A2, is disposed at a position separated from the body of the occupant. Therefore, in order to cover the front opening of the ventilation through hole A12 that the extending portion A41 do not reach, the planar member A5 are sewn with the side end of the central cover A2 so as to overlap with the inner surface of the pulling-in portion A21.

The planar member A5 is made of a cloth-like material such as a carpet that is softer than the flow path cover A4 and harder than the central cover A2, with air permeability equivalent to that of the flow path cover A4. Here, the planar member A5 corresponds to a “second abutting member” of the present disclosure. As the central cover A2 is placed on the central pad A1, the planer member A5 covers the front outer opening of the ventilation through hole A12 and is pressed against the extending portion A41 from the outside in the seat width direction.

As the central cover A2 is pulled-in and fastened to the back surface of the central substrate A3, the planar member A5 is bent so that it is pressed against a part of the flow path cover A4 from the rear side. Thereby, the ventilation through hole A12 is closed from the outside by the planar member A5 and the extending portion A41 over the entire area in the pad thickness direction.

In addition, the extending portion A41 is pressed by the planar member A5 into wide contact with the side surface of the central pad A1. The extending portion A41 closes the ventilation through hole A12 appropriately sealed from the outside.

Since the planar member A5 is sewn with the central cover A2, the planar member A5 is configured to move toward the rear side of the seat together with the central cover A2 when the central pad A1 is bent due to occupant's seating. In other words, the planar member A5 can move relative to the extending portion A41 while sliding toward the rear of the seat together with the central cover A2 when the central pad A1 is bent. Thereby, even though the planar member A5 is composed of a harder material than the central cover A2, it is configured so as not to cause a foreign body sensation when the occupant sits on the seat.

The ventilation through hole A12 shown in FIG. 5 is formed at both ends of the central pad A1 in the seat width direction. Therefore, the ventilation through hole A12 faces to a triangular gap T which is formed at the boundary on the seat front side between the central portion 2A and the side portion 2B. The triangular gap T is a gap portion that opens in a triangular cross section toward the front of the seat. The gap portion is formed by the rounding of both corners caused by the central cover A2 being stretched over the central pad A1 of the central portion 2A, and the rounding of inner corners caused by the side cover B2 being stretched over the side pad B1 of the side portion 2B.

The triangular gap T is formed along the boundary between the central portion 2A and the side portion 2B and extend continuously over the entire seat height direction. By having the ventilation through hole A12 facing the triangular gap T, even if the central pad A1 is collapsed when an occupant sits on the seat, the ventilation through hole A12 is easily maintained in a state of being flow communicated with the outside via the triangular gap T. Therefore, the ventilation through hole A12 is less likely to be blocked by the occupant's body. The ventilation through hole A12 can be properly ventilated.

As shown in FIG. 3, the ventilation through holes A12 formed in the central portion 2A are arranged to match the physique of the occupant, i.e., the shape of the torso which becomes wider as it goes up. So, the four upper ventilation through holes A12 arranged in symmetrical positions are shifted outward in the seat width direction compared to the six lower ventilation through holes A12 arranged in symmetrical positions. According to the present embodiment, the central portion 2A has a shape that narrows toward the top.

Even if the central portion 2A has a tapered shape, the ventilation through holes A12 arranged in two symmetrical positions on the upper side can be arranged so as to open outward at both edges of the central portion 2A in the seat width direction, thereby positioning these ventilation through holes A12 closer to the outside. Although each ventilation through hole A12 is arranged in such a position, each ventilation through hole A12 can be properly covered from the outside by the above-mentioned extending portion A41 and the planar member A5.

As shown in FIG. 5, when the central portion 2A and each side portion 2B are assembled to the back frame 3, the central pad A1 and each side pad B1 are set to press against each other in the seat width direction by their respective elastic forces. Thereby, the extending portion A41 and the planar member A5, which covers the ventilation through hole A12 from the outside, are properly pressed against the side surface of the central pad A1. Therefore, the ventilation through hole A12 can be properly closed by the extending portion A41 and the planar member A5.

To summarize the above description, the seat S according to the present embodiment has the following configuration. In the following description, reference numbers in parentheses corresponding to the respective configurations shown in the above embodiment.

A seat (S) has a seat pad (A1, B1) which elastically supports an occupant. The seat pad (A1, B1) has three separated elements. The three elements are a central pad (A1), which is the center portion in the seat width direction, and each side pads (B1), which forms the side portions in the seat width direction.

The central pad (A1) has ventilation through holes (A12) on its side edges facing the side pad (B1) in the seat width direction. The ventilation through hole (A12) penetrates in the pad thickness direction to open outwardly in the seat width direction. The seat (S) further has a first abutting member (A41) which abuts to the side surface of the central pad (A1) so as to cover the ventilation through hole (A12) from the outside in the seat width direction.

By arranging the ventilation through holes (A12) so that they open outward at the side edge of the central pad (A1), the ventilation through holes (A12) can be provided at a position where they are not easily blocked by the occupant's seating. Furthermore, by providing the first abutting member (A41) that covers the ventilation through hole (A12) from the outside in the seat width direction, the sealing property of the ventilation through hole (A12) is improved, and the ventilation through hole (A12) can function properly.

The seat (S) further has a flow path cover (A4) which abuts to the back surface of the pad so as to cover an air distribution groove (A11) formed along the back surface of the central pad (A1). The first abutting member (A41) comprises an extending portion (A41) extending from the side edge of the flow path cover (A4) in the seat width direction.

According to the above configuration, the first abutting member (A41) can be formed rationally by utilizing the configuration of the flow path cover (A4). In detail, when the ventilation through holes (A12) extend continuously from the air distribution groove (A11), it is possible to properly cover the air distribution groove (A11) and the ventilation through holes (A12) by the first abutting member (A41) extending continuously from the flow path cover (A4) which covers the air distribution groove (A11).

The seat (S) further has a central cover (A2) which covers the central pad (A1) from the pad front side. The central cover (A2) has a pulling-in portion (A21). The pulling-in portion (A21) covers the side surface of the central pad (A1). Then, the pulling-in portion (A21) is pulled-in toward the back side of the central pad (A1). The pulling-in portion (A21) presses the first abutting member (A41) against the side surface of the central pad (A1).

According to the above configuration, the pulling-in portion (A21) of the central cover (A2) rationally presses the first abutting member (A41) against the side surface of the central pad (A1). Thereby, the sealing property of the ventilation through hole (A12) can be properly enhanced.

The central cover (A2) further has a second abutting member (A5). When the pulling-in portion (A21) is pulled-in, the first abutting member (A41) and the second abutting member (A5) abut to the central pad (A1) from the outside in the seat width direction. The ventilation through hole (A12) is covered by the first abutting member (A41) and the second abutting member (A5) from the outside in the seat width direction. According to the above configuration, the first abutting member (A41) can be more appropriately pressed against the side surface of the central pad (A1).

Accordingly, the sealing property of the ventilation through hole (A12) can be more properly enhanced. In addition, since both of the first abutting member (A41) and the second abutting member (A5) cover the ventilation through hole (A12) from the outside in the seat width direction, it is possible to shorten the protrusion of the first abutting member (A41) to the front surface of the pad. This reduces the sensation of a foreign object against the first abutting member (A41) when the occupant sits on the seat.

Although an embodiment of the present disclosure has been described, the present disclosure can be implemented in various forms in addition to the above embodiment.
1. The seat of the present disclosure may be applied to vehicles other than automobiles, such as trains, aircraft, and ships. In addition to vehicles, the seat may be applied to various facilities such as sports facilities, theaters, concert halls, event halls, etc. (for non-vehicle use). The configuration of the present disclosure can be applied to a seat cushion as well as a seat back.
2. The covering member, which abut to the side surface of the central pad so as to cover the ventilation through hole from the outside in the seat width direction, may be a member separate from the flow path cover, in addition to a member extending from the flow path cover. The planar member sewn to the central cover as shown in the above embodiment may also be used as the covering member. The covering member may simply abut to the side of the central pad or may be bonded to the side of the central pad.
3. The first abutting member and the second abutting member may be made of the same material as each other or of different materials. The two covering members may be of the same hardness, or one may be made of a harder material than the other. It is also possible to cover the ventilation through holes from the outside in the seat width direction over the entire area in the pad thickness direction with only the covering member without the other member.
4. The central cover may be made of leather such as synthetic leather or natural leather as well as fabric.

According to one aspect of the present disclosure, a seat having a seat pad elastically supporting an occupant, the seat pad comprising three divided elements. The three elements are a central pad forming a center portion in the seat width direction and each side pad forming a side portion in the seat width direction. Ventilation through holes are provided on the side edges of the central pad opposed to the side pad in the seat width direction. The ventilation through hole penetrates in the pad thickness direction so as to open outwardly in the seat width direction. The seat further has a covering member which abuts to the side surface of the central pad so as to cover the ventilation through hole from the outside in the seat width direction.

By arranging the ventilation through holes so that they open outward at the side edge of the central pad, the ventilation through holes can be provided at a position where they are not easily blocked by the occupant's seating. Furthermore, by providing the first abutting member that covers the ventilation through hole from the outside in the seat width direction, the sealing property of the ventilation through hole is improved, and the ventilation through hole can function properly.

According to another aspect of the present disclosure, the seat further has a flow path cover which abuts to the back surface of the pad so as to cover an air distribution groove formed along the back surface of the central pad. The first abutting member comprises an extending portion extending from the side edge of the flow path cover in the seat width direction.

Therefore, the first abutting member can be formed rationally by utilizing the configuration of the flow path cover. In detail, when the ventilation through holes extend continuously from the air distribution groove, it is possible to properly cover the air distribution groove and the ventilation through holes by the first abutting member extending continuously from the flow path cover which covers the air distribution groove.

According to another aspect of the present disclosure, the seat further has a central cover which covers the central pad from the pad front side. The central cover has a pulling-in portion. The pulling-in portion covers the side surface of the central pad. Then, the pulling-in portion is pulled-in toward the back side of the central pad. The pulling-in portion presses the first abutting member against the side surface of the central pad.

Therefore, the pulling-in portion of the central cover rationally presses the first abutting member against the side surface of the central pad. Thereby, the sealing property of the ventilation hole can be properly enhanced.

According to another aspect of the present disclosure, the central cover further has a second abutting member. When the pulling-in portion is pulled-in, the first abutting member and the second abutting member abut to the central pad from the outside in the seat width direction.

Therefore, the first abutting member can be more appropriately pressed against the side surface of the central pad. Accordingly, the sealing property of the ventilation through hole can be more properly enhanced. In addition, since both of the first abutting member and the second abutting member cover the ventilation through hole from the outside in the seat width direction, it is possible to shorten the protrusion of the first abutting member to the front surface of the pad. This reduces the sensation of a foreign object against the first abutting member when the occupant is seated.

The various examples described above in detail with reference to the attached drawings are intended to be representative of the present disclosure and are thus non-limiting embodiments. The detailed description is intended to teach a person of skill in the art to make, use and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved seat, and/or methods of making and using the same.

We claim:

1. A seat comprising:
a seat pad having a central pad and two side pads, wherein the central pad comprises a ventilation through hole having outwardly openings facing the side pad in a seat width direction in a shape penetrating in the pad thickness direction with respect to the central pad; and
a first abutting member covering the ventilation through hole from the outside in the seat width direction.

2. The seat according to claim 1 further has a flow path cover being arranged adjacent to the back surface of the central pad for covering an air distribution groove formed along the back surface of the central pad.

3. The seat according to claim 2, wherein the first abutting member comprises an extending portion being extendable from a side edge of the flow path cover in the seat width direction.

4. The seat according to claim 1 further has a central cover covering the central pad, wherein the central cover has a pulling-in portion covering side surface of the central pad and pulled-in toward the back side of the central pad, and the pulling-in portion presses the first abutting member against the side surface of the central pad.

5. The seat according to claim 4, wherein the central cover further has a second abutting member, and wherein the first abutting member and the second abutting member are adjacent the central pad outwardly in the seat width direction when the pulling-in portion is pulled-in for covering the ventilation through hole.

6. A seat comprising:
a seat pad having a central pad and two side pads, wherein the central pad comprises a plurality of ventilation through holes having outwardly openings facing the side pad in a seat width direction wherein the plurality of ventilation through holes is configured to allow air to pass therethrough;
a back frame configured to support the seat pad from a rear side of the seat;
a first abutting member covering the ventilation through hole from the outside in the seat width direction; and
a blower configured to draw air from the seat pad.

7. The seat according to claim 6, wherein the plurality of ventilation through holes, at least in part, lines up on both upper edges of the central pad so as to open outward in the seat width direction.

8. The seat according to claim 6, where in the plurality of ventilation through holes, at least in part, lines up apart inwardly from the edge of the central portion.

9. The seat according to claim 6, wherein the blower is configured to draw out hot air from a front side of the seat via the plurality of ventilation through holes.
